(19) United States
(12) Patent Application Publication
(10) Pub. No.: US 2007/0145013 A1
(43) Pub. Date: Jun. 28, 2007

(54) Method for polishing workpiece, polishing apparatus and method for manufacturing semiconductor device

(75) Inventors: Kozue Miyake, Kanagawa (JP); Kazumi Sugai, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, Kanagawa (JP)

(21) Appl. No.: 11/708,585

(22) Filed: Feb. 21, 2007

Related U.S. Application Data
(62) Division of application No. 11/012,107, filed on Dec. 16, 2004.

(30) Foreign Application Priority Data
Dec. 17, 2003 (JP) 2003-419532

(51) Int. Cl. C03C 15/00; B44C 1/22; C23F 1/00

(52) U.S. Cl. 216/89; 216/88; 438/692

(57) ABSTRACT

A region being free of groove is provided in a central portion of the polishing pad, and a region having grooves formed thereon is provided the outer portion thereof. A retainer ring surrounds and sustains a circumference portion of the wafer, and a part of the portion that tends to provide higher polishing rate, which is adjacent to the retainer ring in the circumference portion, is disposed so as to face against the region being free of the groove. Then, while pressing the wafer against the polishing pad, the wafer and the polishing pad are rotated in the same direction. Then, the slurry is supplied from a slurry feeding unit to the outer portion of the region being free of groove. Since substantially no slurry is supplied in the region being free of groove, the polishing rate is reduced there, and thus the uniform polishing rate of over the entire wafer is provided.

The present application is based on U.S. application Ser. No. 11/012,107 filed Dec. 16, 2004 and Japanese Patent Application No. 2003-419532 filed Dec. 17, 2003, the whole disclosure of which is hereby incorporated by reference.

### BACKGROUND OF THE INVENTION

1. Field of the Invention

The present invention relates to a method for polishing a workpiece and a polishing apparatus, and also generally relates a method for manufacturing a semiconductor device.

2. Related Art

When a reflow process, an application process such as a spin on glass (SOG) process, or an etch back process, for example, is conducted for planarizing a wafer within a process for manufacturing a semiconductor device including a wafer composed of silicon or the like, it is difficult to planarize over the wider region of the surface of the wafer. Such difficulty may be a considerable barrier for the manufacturing process for the semiconductor device. In such circumstances, a chemical mechanical polishing (CMP) process, which provides a polishing of the surface of the wafer by a combination of a mechanical action and a chemical action, becomes to be a mainstream of the polishing process.

CMP process and polishing apparatus employed for CMP are disclosed in Japanese Patent No. 3,042,593, Japanese Patent Laid-Open No. H08-229,805, Japanese Patent Laid-Open No. 2003-260,657, Japanese Patent No. 3,324,643, and Japanese Patent No. 3,006,568. In the polishing device disclosed in Japanese Patent No. 3,042,593, a polishing pad (abrasive cloth) is put on a rotatable circular table, and a career, which rotates and moves a wafer (workpiece) while sustaining the wafer so as to maintain the wafer facing against the polishing pad, is provided.

The wafer is polished by pressing the wafer against the polishing pad while rotating the polishing pad and the wafer in the same direction, and further reciprocating and swinging or oscillating the carrier along the direction of crossing the rotating direction (for example, radial direction). More specifically, grooves and/or pores are formed on the polishing pad composed of polyurethane or the like, and an abrasive material (slurry) is supplied to the polishing pad. The slurry is transferred through the grooves to respective portions of the polishing pad and remained within the pores, and the remained slurry is utilized to polish the entire surface of the wafer. The technology disclosed in Japanese Patent No. 3,042,593 comprises the grooves on the polishing pad that are useful in preventing a phenomenon of the wafer sticking on the pad, which is caused by a negative pressure generated therein under the condition of the wafer being closely contacted onto the polishing pad. In addition, sufficient strength of the polishing pad is ensured by adjusting the interval (density) of the grooves and the interval (density) of the pores.

A polishing pad disclosed in Japanese Patent Laid-Open No. H08-229,805 is also available to be employed in a polishing apparatus, which is substantially similar to that disclosed in Japanese Patent No. 3,042,593. Further, the polishing pad of Japanese Patent Laid-Open No. H08-229,805 comprises independent two regions, which includes a region where grooves for allowing the transfer of the slurry therethrough are formed, and a region where pores for maintaining the slurry therein are formed. More specifically, the regions having grooves formed therein are disposed in an inner portion and a circumference portion of the polishing pad, and another region containing pores formed therein is also disposed between the inner portion and the outer circumference portion. In this case, no pore is formed in the region where the grooves are formed, and no groove is formed in the region where the pores are formed. Polishing at higher polishing rate can be achieved at the region where the pores are formed, compared with the region where grooves are formed. This is because the slurry contained within the pores as if being fixed therein provides more compressive polishing of the surface of the wafer than the slurry freely transferring through the grooves. Uniform conditions for polishing the entire wafer can be achieved by polishing the central portion of the wafer that provides shorter moving distance in a unit angular movement of the rotation thereof at a higher polishing rate with the region of the pad where pores are formed, in the technology disclosed in Japanese Patent Laid-Open No. H08-229,805.

In addition, the second example disclosed in Japanese Patent Laid-Open No. H08-229,805 includes a configuration, in which a region having pores formed therein at lower density is disposed in the inner portion and the outer circumference portion of the polishing pad, and a region having pores formed therein at higher density is disposed between the inner portion and the outer circumference portion. Since the region having pores formed therein at higher density is capable of maintaining more slurry than the region having pores formed therein at lower density, the region having pores at higher density can provide the polishing at higher polishing rate. Therefore, similarly as in the aforementioned configuration, uniform polishing condition can be achieved.

Japanese Patent Laid-Open No. 2003-260,657 discloses a configuration in FIG. 1 to FIG. 4, in which widths of concave portions of grooves for transferring the slurry formed on the principal surface of the polishing pad are not constant. In this configuration, the concave portions in the grooves in the inner side of the polishing pad are formed to have narrower widths and the concave portions in the grooves in the circumference side are formed to have wider widths, so that the amount of the slurry fed into the polishing pad is provided as uniformly possible over the entire polishing pad.

### SUMMARY OF THE INVENTION

We have now discovered the following. FIG. 15A is a schematic side view of a conventional polishing apparatus, showing the configuration thereof. As shown in FIG. 15A, a carrier sustaining thereon a wafer 101 to be polished typically comprises a retainer ring 102a surrounding a circumference portion of the wafer 101 for sustaining the wafer 101 with higher reliability.

The retainer ring 102a is often in contact with a surface of a polishing pad 103 when the wafer 101 is polished by providing a compressible contact with the polishing pad 103, in which the slurry 108 is supplied. Since the wafer 101 and the polishing pad 103 rotate and/or oscillate in the condition that the retainer ring 102a is in compressible contact with the polishing pad 103 of a thin cloth in such occasion, the polishing pad 103 is in a condition of floating itself (or bouncing) in a periphery of a position where the retainer ring 102a makes a compressible contact, as shown in FIG. 15B. Since the polishing pad 103 is compressed against the wafer 101, which is shown by the two-dot chain line in the figure, the pressure generated by the compressible contact between the wafer 101 and the polishing pad 103 tends to be increased in the periphery of the retainer ring 102a or namely in the circumference portion of the wafer 101, even though the polishing pad 103 actually does not extremely distorted as shown by the exaggerated diagram in FIG. 15B. As a result, the polishing rate is higher in the circumference portion compared with the central portion of the wafer 101, as shown in FIG. 16. For example, in the case of the wafer 101 having a diameter of about 200 mm, the polishing rate is higher by 10 to 15% in a toroidal region having a width of about 10 mm from the circumference edge of the wafer than in the central portion thereof. More specifically, when the polishing rate in the central portion thereof is 200 nm/min, the polishing rate in the circumference portion may be 220 to 230 nm/min.

Although the technology disclosed in Japanese Patent No. 3,042,593 allows uniformly increasing and decreasing the polishing rate for the entire wafer, it may be difficult to prevent to generate a region for presenting higher polishing rate and a region for presenting lower polishing rate within the wafer, thereby providing uneven surface condition of the wafer, as shown in FIG. 15B and FIG. 16.

On the other hand, the technology disclosed in Japanese Patent Laid-Open No. H08-229,805 provides a region where higher polishing rate is obtained than other region in the polishing pad (region where pores are formed or perforated region), and thus polishing the wafer by utilizing such region of the pad provides uniform polishing rate across the surface of the wafer and, in turn, provides uniform surface condition of the polished wafer.

Nevertheless, the configuration disclosed in Japanese Patent Laid-Open No. H08-229,805 requires to form a new type of a polishing pad, which is totally different from the conventionally employed (for example, commercially available) polishing pad. Moreover, the manufacture of such new type of polishing pad is complicated, and the manufacturing cost may be high. More specifically, a process for forming grooves including, for example, a process for rotating the polishing pad while a tool having a blade shape is pressed against the polishing pad, and a process for forming pores including, for example, a process for stinging a needle-shape tool into the polishing pad, are necessary to be carried out for manufacturing each piece of the polishing pad. As such, at least two different operations must be conducted for forming the grooves and the pores in one piece of the polishing pad.

Since the size of the region where pores are formed is determined according to the size of the wafer, the configuration may not possibly be generally adopted for polishing the wafers having different sizes. This problem will be further described as follows.

In the first place, it can be considered that Japanese Patent Laid-Open No. H08-229,805 is presented by recognizing the tendency of the polishing rate, which is reduced due to the narrower moving range thereof in vicinity of the center of the wafer. However, another type of problem that is not related to Japanese Patent Laid-Open No. H08-229,805 is arisen, where the polishing rate is increased as the polishing pad is to be distorted at the periphery of the retainer ring that is caused by the compressive contacts with the retainer ring in the circumference portion of the wafer. (see FIG. 15B and FIG. 16). The problem is a tendency, in which, as described above, higher polishing rate is obtained in a toroidal region having a width of about 10 mm from the circumference edge of the wafer (in other words, circumference portion) and lower polishing rate is obtained in other region (that is, central portion).

When the configuration of Japanese Patent Laid-Open No. H08-229,805 is applied thereto to polish the central portion of the wafer (in other words, portions except the toroidal region having width of about 10 mm from the circumference edge) with the region of the polishing pad having pores formed therein, it may be considered that uniform polishing condition can be achieved. In such case, since the range on the surface of the wafer to be polished with the region of the polishing pad having pores formed therein is different between the case of polishing a wafer having smaller diameter and the case of polishing a wafer having larger diameter, it is naturally desired that the geometry of the region of the polishing pad having pores should be suitably selected. Specifically describing thereof in simple examples: when a wafer 104 having a diameter of 200 mm is polished as shown in FIG. 17A, a portion 104a of a diameter of about 180 mm should be polished with a region 105a of the polishing pad 105 having pores formed therein, and when a wafer 106 having a diameter of 300 mm is polished as shown in FIG. 17B, a portion 106a of a diameter of about 280 mm should be polished with a region 107a of the polishing pad 107 having pores formed therein. Therefore, it is desired that the sizes of the regions 105a and 107a both having pores formed therein should be suitably selected corresponding to the sizes of the wafer 104 and the wafer 106, as shown in FIG. 17A and FIG. 17B, respectively. It is considered that this is because the phenomenon of causing the floating (or bouncing) of the polishing pad 103 in a periphery of the retainer ring 102a occurs within a certain range thereof regardless of the size of the wafer, as shown in FIG. 15B.

Here, it is assumed that the oscillating ranges of the wafer 104 and the wafer 106 are almost fixed in the cases of FIG. 17A and FIG. 17B, respectively. It can also be expected that a polishing pad 107 including smaller region 107a having pores formed therein can be available for polishing the larger wafer 106 by increasing the oscillating range thereof. However, in such case, the oscillating ranges should be considerably changed on a case-by-case base according to the sizes of the wafer 104 and the wafer 106, and thus complicated apparatus structure and complicated polishing process are required, and the whole size of the polishing apparatus and the manufacturing cost may be increased.

As such, when the configuration of Japanese Patent Laid-Open No. H08-229,805 is applied thereto to solve the problem of difficulty in obtaining uniform polishing rates as shown in FIG. 15A, FIG. 15B and FIG. 16 without further consideration, it is difficult to be generally adapted to different wafer sizes by utilizing a single polishing pad. Therefore, the respective polishing pads containing the region having pores formed therein, which have appropriate sizes that meet the respective sizes of the wafers, are necessary to be prepared in respective cases of polishing wafers of various sizes. According to Japanese Patent Laid-Open No. H08-229,805, the polishing pads having novel configuration that has not been presented in the conventional technology should be tailored to comply with the different wafer sizes in each time of polishing wafers having different sizes, and thus the production cost for wafers may be increased.

In addition, the type of the polishing pad including the region having pores formed therein as disclosed in Japanese Patent Laid-Open No. H08-229,805 may possibly cause a plugging of the pad due to a local drying-up, and thus there is a possibility to cause a scratch on the polished wafer.

Uniform feeding quantity of the slurry into the principal surface of the polishing pad is aimed in the technology disclosed in Japanese Patent Laid-Open No. 2003-260,657. However, inventors of Japanese Patent Laid-Open No. 2003-260,657 does not seem to consider the fact that the portion of the workpiece of wafer for providing higher polishing rate exists as described above. Therefore, even if the amount of the polishing by the slurry is controlled to be uniform as described in Japanese Patent Laid-Open No. 2003-260,657, it is highly possible to provide no contribution for achieving uniform polishing conditions of the polished wafers. More specifically, the technology described in Japanese Patent Laid-Open No. 2003-260,657 is made by only considering on how the quantity of the slurry feed is controlled, and thus the technology described in Japanese Patent Laid-Open No. 2003-260,657, which does not focus on the tendency of the polishing rate of the workpiece of the wafer, is not always effective in the real polishing operation.

Therefore, the present invention is made on the basis of particularly focusing on the fact that the polishing rate of the circumference portion of the workpiece such as wafer sustained on the ring-type retainer such as retainer ring is higher, and the present invention provides a technology of presenting a uniform polishing rate over the workpiece in a real polishing operation to provide a uniform surface condition over the workpiece.

According to one aspect of the present invention, there is provided a method for polishing a workpiece, comprising: providing a compressible contact between a principal surface of a polishing pad and a polishing surface of a workpiece; continuously moving a relative position of the polishing pad with the workpiece while the condition of being in compressible contact between the principal surface of the polishing pad and the polishing surface of the workpiece is maintained; and supplying an abrasive material between the polishing pad and the workpiece, wherein quantity of the abrasive material contacting the workpiece has a distribution profile over a region where the principal surface of the polishing pad is in contact with the polishing surface of the workpiece. The abrasive material has the distribution profile over the polishing pad.

Here, “the region where the principal surface of the polishing pad and the polishing surface of the workpiece are in contact” utilized in the present invention indicates a region in the principal surface of the polishing pad, on, over or above which the workpiece can be disposed, and these may be directly contacted or an abrasive material may be disposed therebetween, provided that the principal surface of the polishing pad faces against the polishing surface of the workpiece.

In the present invention, the workpiece may be exemplified by semiconductor wafer and glass substrate, which may include predetermined devices thereon.

According to the present invention, since the abrasive material is supplied so that the quantity of the abrasive material contacting the workpiece has a distribution profile in a region where a principal surface of the polishing pad and a polishing surface of the workpiece are in contact, the polishing rate is reduced in the region of containing smaller amount of the abrasive material that contacts the workpiece, and thus the polishing rate can be suitably controlled within the polishing surface of the workpiece by utilizing such distribution profile of the quantity of the abrasive material. Therefore, uniform polishing rate can be obtained in a simple process with lower cost.

The aspect of the present invention may further comprise an additional configuration, in which the aforementioned process of supplying the abrasive material may include supplying the aforementioned region so that the quantity of the abrasive material supplied within a unit area of the aforementioned principal surface in a unit time is not uniform across the aforementioned region.

The aspect of the present invention may further comprise an additional configuration, in which the shape of the aforementioned principal surface of the polishing pad is a circle, and the aforementioned process of supplying the abrasive material may include supplying the aforementioned abrasive material so that the quantity of the abrasive material supplied within a unit area of the aforementioned principal surface in a unit time varies at any position along the direction of the radius of the polishing pad to form a distribution profile thereof.

The aspect of the present invention may further comprise an additional configuration, in which the polishing pad is rotated around a central axis, and the workpiece is oscillated on a region where the abrasive material has a distribution profile. Having such configuration, uniform polishing rate can more definitely be achieved.

The aspect of the present invention may further comprise an additional configuration, in which quantity of the abrasive material is lower in a location that is closer to the center than a position where the abrasive material is dropped, and quantity of the abrasive material is higher in a location that is closer to the outer circumference than the position. This may be effective since the polishing pad rotates during the polishing process to generate a centrifugal force, which, in turn, substantially prevents the abrasive material moving toward the center from the dropping position of the abrasive material.

The aspect of the present invention may further comprise an additional configuration, in which the polishing pad is provided with grooves formed thereon, and wherein, on the polishing pad, quantity of the abrasive material is lower in a region where density of the grooves is lower, and quantity of the abrasive material is higher in a region where density of the grooves is higher. This may be effective since the amount of the abrasive material transferred to the region having lower density of the grooves is smaller. Here, the density of the grooves appeared in this specification indicates areas of regions occupied by the grooves per unit area of the polishing pad, viewing from a normal line direction of the principal surface of the polishing pad.

The aspect of the present invention may further comprise an additional configuration, in which density of the grooves is lower in a central region of the polishing pad, and density of the grooves is higher in a circumference region thereof. In addition, the central region of the polishing pad may be free of the groove. Having such configuration, the distribution profiles of the quantity of slurry feed are definitely presented in the central region and the circumference region of the polishing pad. Therefore, the polishing rate can more definitely be controlled over the polishing surface.

The aspect of the present invention may further comprise an additional configuration, in which the polishing pad is provided with grooves formed therein, and wherein, on the polishing pad, quantity of the abrasive material is lower in a region where a width of a concave portion in the groove is narrower, and quantity of the abrasive material is higher in a region where a width of a concave portion in the groove is wider. The width of the concave portion in the groove may be narrower in the central region of polishing pad, and the width of the concave portion in the groove may be wider in the circumference region of the polishing pad.

The aspect of the present invention may further comprise an additional process of providing a compressible contact between a principal surface of the polishing pad and a polishing surface of the workpiece, so that at least a portion on the polishing surface of the workpiece, which tends to provide higher polishing rate, is located in a region on the principal surface of the polishing pad, which contains less quantity of the abrasive material. Having such additional process, more uniform polishing rate can be stably achieved. More specifically, the present invention is not intended to simply providing uniform feeding of the abrasive material, but allows providing uniform polishing rate in the real polishing process by providing a distribution profile of the feed quantity of the abrasive material in consideration of the tendency of the polishing rate for the workpiece.

The aspect of the present invention may further comprise an additional process of: acquiring a tendency of a distribution profile of the polishing rate in the aforementioned polishing surface of the workpiece; and determining a region of the workpiece located over the polishing pad based on the acquired tendency, wherein the aforementioned process for continuously moving the relative position of the polishing pad and the workpiece can be conducted within the determined region. Having such additional process, the tendency of the distribution profile of the polishing rate can be acquired using a dummy workpiece in advance, and thus the variation of the polishing rates for products within the polishing surface of the workpiece can definitely be prevented.

The aspect of the present invention may further comprise an additional configuration, in which a ring-type retainer surrounds a circumference portion of the workpiece to sustain the workpiece, and wherein the portion on the polishing surface of the workpiece, which tends to provide higher polishing rate, is a portion of the circumference portion being adjacent to the ring-type retainer.

According to another aspect of the present invention, there is provided a method of polishing a workpiece, comprising: providing a compressible contact between a principal surface of a polishing pad and a polishing surface of a workpiece; continuously moving a relative position of the polishing pad against the workpiece while the condition of being in compressible contact between the principal surface of the polishing pad and the polishing surface of the workpiece is maintained; and supplying an abrasive material between the polishing pad and the workpiece, wherein a circumference portion of the workpiece is sustained with a ring-type retainer, and wherein a portion of the ring-type retainer forces the polishing pad and the workpiece so that the polishing pad is in compressible contact with the workpiece, while the ring-type retainer is disposed so that at least a portion of the ring-type retainer extends beyond an edge of the polishing pad. Since this configuration includes disposing the ring-type retainer so that at least a portion of the ring-type retainer extend beyond the polishing pad, the distortion of the polishing pad caused by the compressible contact of the ring-type retainer against the polishing pad can be reduced. Therefore, the increase of the polishing rate in that portion can be inhibited.

According to further aspect of the present invention, there is provided a polishing pad for polishing a workpiece by forcing a rotating workpiece to provide a compressible contact between the workpiece and the polishing pad and by supplying abrasive material between the workpiece and the polishing pad while the polishing pad being rotated, wherein the polishing pad is partially provided with grooves formed therein, and wherein density of the grooves has a distribution profile across a principal surface of the polishing pad, thereby the polishing pad being provided with a first region having lower polishing rate and a second region having higher polishing rate.

Since the density of the grooves is not uniformly distributed over the surface of the polishing pad according to the aspect of the present invention, the polishing rate can be uniformly distributed over the surface corresponding to the non-uniformity of the groove density, even if the polishing rate for the workpiece has not been uniformly distributed over the polishing surface.

The aspect of the present invention may further comprise an additional configuration, in which the density of the groove on the polishing pad is lower in a region of the polishing pad corresponding to higher polishing rate portion of the workpiece and the density of the groove on the polishing pad is higher in a region of the polishing pad corresponding to lower polishing rate portion of the workpiece. The aspect of the present invention may further comprise an additional configuration, in which a width of a concave portion in the groove of the polishing pad is narrower in a region of the polishing pad corresponding to higher polishing rate portion of the workpiece and a width of a concave portion in the groove of the polishing pad is wider in a region of the polishing pad corresponding to lower polishing rate portion of the workpiece. The configuration of the present invention may further comprise an additional feature, in which the density of the grooves is lower in a central region of the polishing pad, or the width of the concave portion in the groove is narrower in a central region of the polishing pad. Alternatively, the aspect of the present invention may further comprise an additional configuration, in which the central region of the polishing pad is free of the groove.

The aspect of the present invention may further comprise an additional configuration, in which the grooves are concentric circular.

According to yet other aspect of the present invention, there is provided a polishing apparatus, comprising a polishing pad having any one of the aforementioned configurations. According to the polishing apparatus of the present invention, the workpiece can be uniformly polished within polishing surface.

The aspect of the present invention may further comprise an additional configuration, in which the polishing apparatus further comprises: a polishing pad driving unit which rotates the polishing pad; an abrasive material feeding unit which supplies an abrasive material to a predetermined position on the polishing pad; and a workpiece driving unit which rotates the workpiece while forcing the workpiece so that the workpiece is in compressible contact with the polishing pad.

The aspect of the present invention may further comprise an additional configuration, in which the polishing pad driving unit and the workpiece driving unit comprise a mechanism for providing a compressible contact between a principal surface of the polishing pad and a polishing surface of the workpiece so that at least a portion of the polishing surface of the workpiece having tendency to provide higher polishing rate is located in a region containing smaller amount of the abrasive material of a principal surface of the polishing pad. Having such configuration, the variation of the polishing rate can be definitely inhibited.

The aspect of the present invention may further comprise an additional configuration, in which the workpiece driving unit comprises a ring-type retainer for surrounding a circumference portion of the workpiece to sustain the workpiece, and wherein the portion of the polishing surface of the workpiece having tendency to provide higher polishing rate is a portion of a circumference portion being adjacent to the ring-type retainer.

According to yet further aspect of the present invention, there is provided a polishing apparatus, comprising: a polishing pad; a polishing pad driving unit which rotates the polishing pad; and a workpiece driving unit which forces the workpiece so that the workpiece compressibly contacts the polishing pad while rotating the workpiece, the workpiece driving unit comprising a ring-type retainer for surrounding a circumference portion of the workpiece to sustain the workpiece, and the workpiece driving unit being capable of sustaining the workpiece thereon so that at least a portion of the ring-type retainer extends beyond an edge of the polishing pad.

According to the configuration described above, since the workpiece driving unit sustains the workpiece so that at least a portion of the ring-type retainer extend beyond the polishing pad, the distortion of the polishing pad caused by the compressible contact of the ring-type retainer against the polishing pad can be reduced. Therefore, the increase of the polishing rate in the portion can be inhibited.

According to yet other aspect of the present invention, there is provided a method for manufacturing a semiconductor device, comprising: creating a conducting region within a wafer by utilizing an ion implantation technology; forming an insulating layer and/or a conducting layer by utilizing a deposition technology, both of the layers composing a portion of the wafer; processing the wafer into a predetermined shape by utilizing a lithography technology; and recognizing the wafer as a workpiece and conducting any one of the aforementioned methods for polishing the workpiece.

According to yet further aspect of the present invention, there is provided a method for manufacturing a semiconductor device, comprising: forming an insulating film on a semiconductor substrate; and polishing a surface of the insulating film to planarize the surface of the insulating film, wherein the polishing is conducted by utilizing any one of the aforementioned methods for polishing the workpiece.

According to yet other aspect of the present invention, there is provided a method for manufacturing a semiconductor device, comprising: forming an insulating film on a semiconductor substrate; forming a groove on the insulating film; forming a conducting film within the groove and on the insulating film; and polishing at least a portion of the conducting film formed on the insulating film to planarizing a surface composed of the surface of the insulating film and the surface of the conducting film, wherein the polishing is conducted by utilizing any one of the aforementioned methods for polishing the workpiece.

According to these methods for manufacturing semiconductor devices, planarization process for the wafer can be conducted with higher reliability, and thus the resultant semiconductor devices having desired performances can be manufactured with higher accuracy.

Although the workpiece often includes a portion that tends to partially provide higher polishing rate, the present invention appropriately reduces the polishing rate in such portion, thereby providing uniform polishing rate over the entire workpiece. This, in turn, allows providing higher flatness of the workpiece. Moreover, there is a slim chance to increase the manufacturing cost and to provide complicated polishing apparatus and polishing process.

In particular, when the workpiece is sustained on the ring-type retainer, an increase of the polishing rate in the location in vicinity of the ring-type retainer can be effectively inhibited.

Eventually, the polishing method according to the present invention can be employed to manufacture the semiconductor device having desired characteristics in a simple and accurate manner.

### BRIEF DESCRIPTION OF THE DRAWINGS

The above and other objects, advantages and features of the present invention will be more apparent from the following description taken in conjunction with the accompanying drawings, in which:

FIG. 1A is a schematic side-view of a polishing apparatus of the first embodiment of the present invention;

FIG. 1B is a plan view of a polishing pad of the polishing apparatus of the first embodiment, showing the configuration thereof;

FIG. 2 is a flow chart, showing the polishing method of the first embodiment according to the present invention;

FIG. 3 is a graph showing the relationship of the position of the wafer with a polishing rate according to the first embodiment of the present invention;

FIG. 4 is a plan view of the polishing pad of the polishing apparatus of the second embodiment according to the present invention, showing the configuration thereof;

FIG. 5 is a plan view of the polishing pad of the polishing apparatus of the third embodiment according to the present invention, showing the configuration thereof;

FIG. 6 is a plan view of the polishing pad of the polishing apparatus of the fourth embodiment according to the present invention, showing the configuration thereof;

FIG. 7 is a plan view of the polishing pad of the polishing apparatus according to the modified configuration of the first embodiment of the present invention;

FIG. 8 is a plan view of the polishing pad of the polishing apparatus according to another modified configuration of the first embodiment of the present invention;

FIG. 9A is a plan view of the polishing pad of the polishing apparatus according to further modified configuration of the first embodiment of the present invention;

FIG. 9B is a cross-sectional view of the polishing pad of FIG. 9A, showing the configuration thereof;

FIG. 10A is a schematic side view of the polishing apparatus of the fifth embodiment according to the present invention, showing the configuration thereof;

FIG. 10B is a plan view of the polishing pad of the polishing apparatus of the fifth embodiment according to the present invention, showing the configuration thereof;

FIG. 11 is a schematic enlarged side view of the portion of the polishing apparatus shown in FIG. 10A;

FIG. 12 is a flow chart, showing the polishing method of the fifth embodiment according to the present invention;

FIG. 13A is a schematic cross-sectional view of a semiconductor device, showing a process for manufacturing the semiconductor device according to an embodiment of the present invention;

FIG. 13B is a schematic cross-sectional view of the semiconductor device, showing the process for manufacturing the semiconductor device according to the embodiment of the present invention;

FIG. 13C is a schematic cross-sectional view of the semiconductor device, showing the process for manufacturing the semiconductor device according to the embodiment of the present invention;

FIG. 13D is a schematic cross-sectional view of the semiconductor device, showing the process for manufacturing the semiconductor device according to the embodiment of the present invention;

FIG. 13E is a schematic cross-sectional view of the semiconductor device, showing the process for manufacturing the semiconductor device according to the embodiment of the present invention;

FIG. 13F is a schematic cross-sectional view of the semiconductor device, showing the process for manufacturing the semiconductor device according to the embodiment of the present invention;

FIG. 14A is a schematic cross-sectional view of the semiconductor device, showing the process for manufacturing the semiconductor device according to the embodiment of the present invention;

FIG. 14B is a schematic cross-sectional view of the semiconductor device, showing the process for manufacturing the semiconductor device according to the embodiment of the present invention;

FIG. 14C is a schematic cross-sectional view of the semiconductor device, showing the process for manufacturing the semiconductor device according to the embodiment of the present invention;

FIG. 14D is a schematic cross-sectional view of the semiconductor device, showing the process for manufacturing the semiconductor device according to the embodiment of the present invention;

FIG. 15A is a schematic side view of a conventional polishing apparatus for explaining the problem of the conventional polishing apparatus;

FIG. 15B is an enlarged view of a part of the conventional polishing apparatus shown in FIG. 15A for explaining the problem of the conventional polishing apparatus;

FIG. 16 is a graph, showing a relationship of a position of a wafer with a polishing rate within the conventional polishing apparatus shown in FIG. 15A for explaining the problem of the conventional polishing apparatus;

FIG. 17A is a plan view of the polishing pad and a part of the wafer, showing an example of the conventional polishing apparatus suitable for polishing a smaller wafer for explaining the problem of the prior art; and

FIG. 17B is a plan view of the polishing pad and a part of the wafer, showing an example of the conventional polishing apparatus suitable for polishing a larger wafer for explaining the problem of the prior art.

### DETAILED DESCRIPTION OF THE PREFERRED EMBODIMENT

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Preferable embodiments according to the present invention will be described as follows in reference to the annexed figures. In all figures, identical numeral is assigned to an element commonly appeared in figures, and the detailed description thereof is not presented.

### First Embodiment

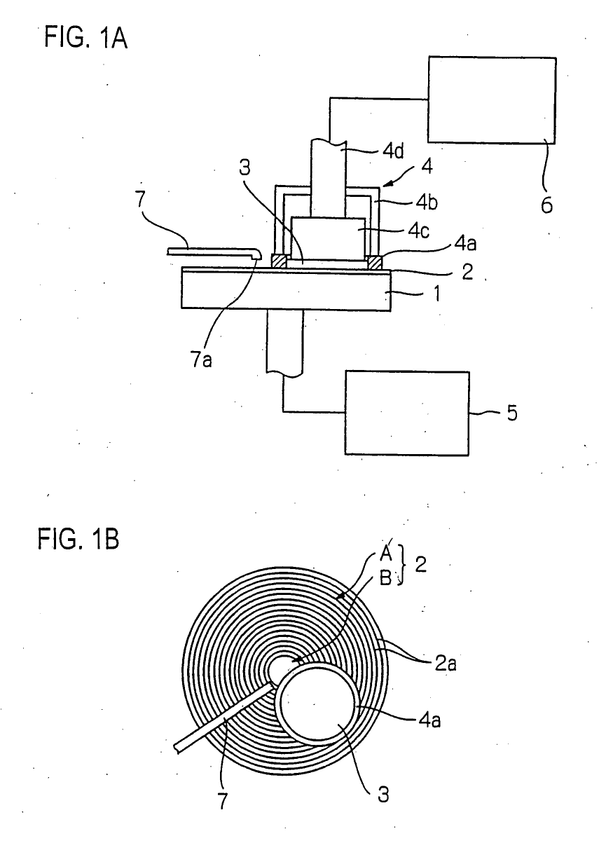

FIG. 1A and FIG. 1B present schematic diagrams, showing a configuration of a polishing apparatus according to the present embodiment. FIG. 1A is a cross-sectional view of the polishing apparatus. FIG. 1B is a plan view, showing a polishing pad 2, a slurry feeder 7, a carrier 4 and a wafer 3 sustained on the polishing apparatus shown in FIG. 1A. The polishing apparatus shown in FIGS. 1A and 1B will be described. Basic configuration of this polishing apparatus is substantially the same as the conventional apparatus. More specifically, the polishing pad (abrasive cloth) 2 is put on a rotatable table 1, and the carrier 4 for maintaining the wafer (workpiece) 3 is provided so as to face against the polishing pad 2. Further, the slurry feeder 7, which is capable of dropping an abrasive material (slurry) 8 (see FIG. 11) is provided above the polishing pad 2. An illustrative example thereof may be that the table 1 is a circular member having a diameter of about 500 mm, and is capable of being rotated by a table driving device 5 that is schematically shown here. The combination of the table 1 and the table driving device 5 act as a polishing pad driving unit. The carrier 4 comprises a retainer ring (ring-type retainer) 4a surrounding a circumference portion of the wafer 3, a retainer base 4b sustaining the retainer ring 4a, a carrier head 4c pressing down the wafer 3 and a spindle 4d, which is a rotary drive shaft for the rotation of these components that are incorporated when rotated. A carrier driving device 6, which is capable of integrally rotating and moving the whole of the carrier 4 and is also capable of pressing against the retainer ring 4a and the wafer 3 to provide a compressible contact of them with the polishing pad 2, is coupled to the spindle 4d. The combination of the carrier 4 and the carrier driving device 6 act as a workpiece driving unit. In the present embodiment, the wafer 3 to be polished is a circular wafer having a diameter of about 200 mm.

Next, the polishing pad 2 of the present embodiment will be described in reference to FIG. 1B. The polishing pad 2 is formed of a suitable material such as polyurethane or the like, and is a circular member having a diameter of about 500 mm, similarly as the table 1. A polishing surface (principal surface that contacts the wafer) of the polishing pad 2 comprises a region “A” having grooves 2a formed thereon, and a region “B” being free of groove 2a. More specifically, the region B having no groove 2a formed therein is provided in a rotary central portion of the circular polishing pad 2 (for example, circular region having a diameter of about 50 mm), and the outer side thereof, the region A having grooves 2a formed thereon is provided. In the present embodiment, the grooves 2a formed in the region A are a plurality of concentric circles, and the depth is about 0.3 to 1.0 mm.

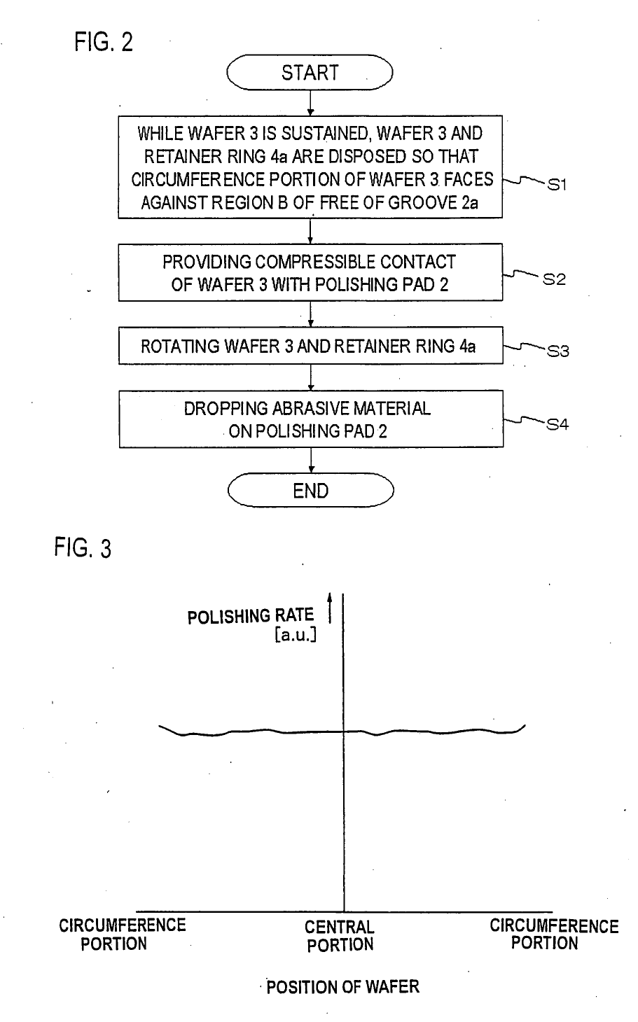

Polishing process for the wafer 3 by employing the wafer polishing apparatus as shown in FIGS. 1A and 1B will be described in reference to the flowchart shown in FIG. 2.

First, the retainer ring 4a surrounds a circumference portion of the wafer 3 to sustain it, and, as described above, the wafer 3 and the retainer ring 4a are disposed on a predetermined position on the polishing pad 2 including the region B being free of groove 2a, namely a region where the slurry 8 is difficult to be supplied, so as to provide lower polishing rate compared with that of another region A (step S1). More specifically, the wafer 3 and the retainer ring 4a are sustained so that a portion of the circumference portion (portion that tends to provide higher polishing rate) of wafer 3 faces to the region B being free of groove 2a, thereby providing a compressible contact with the polishing pad 2 (step S2). Then, the polishing pad 2 is rotated by the table 1 and the table driving device 5, and the wafer 3 is rotated by the carrier 4 and the carrier driving device 6 (step S3).

More specifically, while the retainer ring 4a and the wafer 3 are pressed against the polishing pad 2 at a pressure of, for example, 0.5 to 10.0 psi, a combination of the table 1 and the polishing pad 2 and a combination of the retainer ring 4a and the wafer 3 are respectively rotated in the same direction (for example, anti-clock direction) at a constant speed of, for example, 20 to 200 rpm (an example may be at 100 rpm). In this occasion, the retainer ring 4a and the wafer 3 are reciprocated and oscillated along the direction of intersecting the rotating direction (for example, radial direction) by the carrier driving device 6. The oscillating range is about 5 to 50 mm (an example may be 10 mm), and the period thereof is 5 seconds to 1 minute (an example may be 10 seconds).

Then, the slurry 8 is dropped onto the polishing pad 2 (step S4). In this occasion, a drop port 7a (see FIG. 1A) of the slurry feeder 7 is located outside of the region B of the polishing pad 2 having no groove 2a. Therefore, the slurry 8 containing silica, alumina, cerium oxide or the like is dropped onto the region A having grooves 2a formed thereon.

As such, as shown in FIG. 1B, the polishing operation is conducted so that the circumference portion of the wafer 3, that is, the portion that provides higher polishing rate around the retainer ring 4a, as described above (for example, region having a width of about 10 mm from the circumference edge), is located in the region B being free of groove 2a of the rotary center portion of the circular polishing pad 2. The retainer ring 4a and the wafer 3 are reciprocating and oscillating to continue to relatively move the wafer 3 against the polishing pad 2, and it is preferable that the circumference portion of wafer 3 (for example, region having a width of about 10 mm from the circumference edge) is in contact with the region B of free of groove, as described above, as taking an average during the polishing operation.

When the wafer 3 is polished in such manner, the slurry 8 moves through the grooves 2a on the polishing pad 2 and moves from the inner side of the surface of the polishing pad 2 toward the outer side thereof by a centrifugal force. The wafer 3 will be polished by the slurry 8. However, the region B being free of groove 2a is located inner than the slurry dropping position, and since no groove 2a exists there and further the slurry 8 cannot move against centrifugal force, the slurry is never supplied to the region B. Therefore, the region A having grooves 2a formed thereon and the region B being free of groove 2a respectively have a distribution profile of the quantity of the slurry 8 (that is, there are a portion having much amount of the slurry 8 and a portion having with less amount of the slurry 8). Consequently, the polishing rate of the wafer 3 polished in the region B being free of groove 2a (region containing smaller amount of slurry 8) is lower than the polishing rate in the region A having grooves 2a formed thereon (region containing larger amount of slurry).

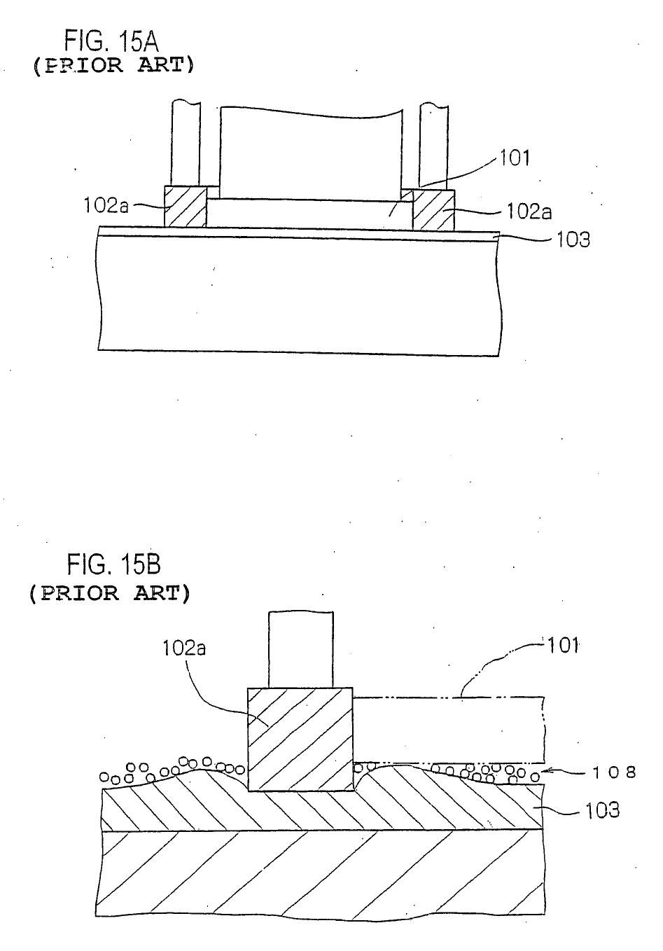

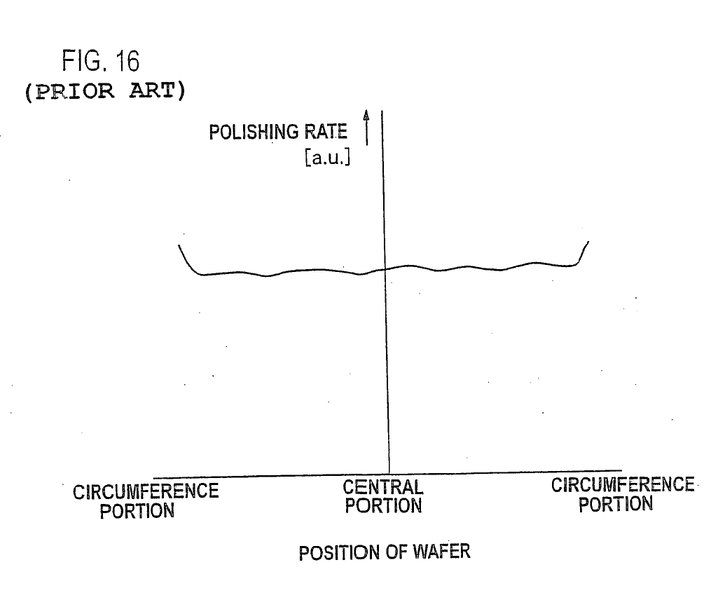

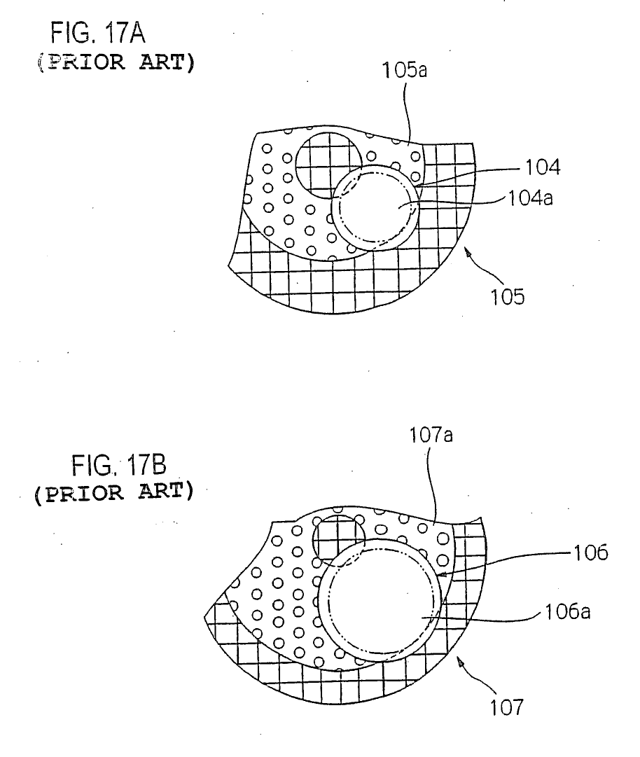

Since the circumference portion of the wafer 3 is polished while maintaining the condition of contacting with the region B being free of groove 2a as mentioned above in the present embodiment, the polishing rate thereof is lower that that in the central portion of the wafer 3. Since the wafer 3 oscillates while rotating during the polishing process, there is no portion that is always polished by the region B of free of groove 2a, and it periodically comes in contact with the region B being free of groove 2a at a frequency of only one time per one rotation of the wafer 3. Nevertheless, after the polishing operation for one wafer 3 for about 30 seconds to 3 minutes is carried out, the polishing rate of the circumference portion of the wafer 3 adjacent to the retainer ring 4a generally reduces to the level equivalent to the polishing rate of the central portion. This can compensate an increase of the polishing rate caused by bouncing (floating) of the polishing pad shown in FIG. 15B. Eventually, as shown in FIG. 3, the polishing rate of the circumference portion can be held down to around±5% of the polishing rate of the central portion. For example, the polishing rate of the central portion may be 200 nm/min, and the polishing rate of the circumference portion may be about 190 to 210 nm/min. In this way, according to the present embodiment, uniform polishing rate over the wafer 3 is provided, and the flatness thereof is improved. Here, the polishing rate means a rate of polishing of the workpiece per unit time, which is observed when the conditions such as compressible contacting pressure, revolution speed, density of slurry 8 and the like are constant.

Exemplary usage of the polishing pad of the present embodiment having no groove in a central portion has been employed in the conventional technology. For example, a polishing pad having no groove in a central portion and having grooves only in the circumference portion is commercially available from Rodel Inc., of Phoenix, Ariz. However, the region of the central portion being free of groove in the conventional technology is intended to only provide a simple handling of the polishing pad and to simplify the whole manufacturing process, and has not been utilized for the polishing process itself. The concept of the technology according to the present invention for actively utilizing the region in the central portion of free of groove in such polishing pad for the polishing operation to achieve an improved control of the polishing rate, has not existed in the conventional technology.

In other words, according to the present embodiment, uniform surface condition of the polished workpiece can be presented for various dimensions of the workpieces by employing the conventionally existing types of the polishing pads. More specifically, the polishing apparatus and the polishing method can be obtained, which provide unexpected advantageous effects of providing the uniform polishing rate and the improved flatness of the wafer without increasing the manufacturing cost of the wafer by employing the conventionally utilized polishing pad.

Here, in the present embodiment and the following other embodiments, a dummy wafer having the dimension and the material same as that of the commercial product wafer may be employed to precedently acquire information on the level of the variation of the polishing rate when the retainer ring 4a is employed, and thereafter, the disposing position for polishing of a product wafer and the distribution of the feeding quantity the slurry 8 or the distribution of groove density on the polishing pad 2 may be determined on the basis of the previously acquired information, and eventually the wafer 3 may be installed at the predetermined position to conduct the polishing operation. This procedure can further improve the uniformity of the polishing.

In addition, the workpiece employed in the present embodiment and the following other embodiments is not limited to the semiconductor substrates such as a silicon substrate and the like, and may be a glass substrate or the like. Further, the polishing apparatus and the polishing method of the present embodiment and the following other embodiments may be employed for applications other than polishing the wafer of the semiconductor substrate, such as for polishing optical lens, for example.

Further, the present embodiment is not intended to be limited to the improvements in the ununiformity of the polishing rate caused by the use of the aforementioned retainer ring 4a, but is also effective for improving the ununiformity in the polishing rate caused by any factors, and further, the location of the ununiformity in the polishing rate of the workpiece may not be regarded.

The manner of feeding the abrasive material such as slurry 8 or the like is not limited to the aforementioned configuration of dropping the abrasive material onto the polishing pad, and an alternative configuration of, for example, supplying the abrasive material from an internal portion of the polishing pad may also be employed.

The present embodiment is advantageous even in the case of employing the polishing pad that is smaller than the workpiece, and also advantageous even in conducting the polishing operation by the action of the polishing pad other than the rotation, such as that the polishing pad moves toward the horizontal direction as a roller manner.

The descriptions of the following embodiments will mainly focus on the points that are different from the first embodiment.

### Second Embodiment

A second embodiment according to the present invention will be described as follows in reference to FIG. 4. Here, an identical numeral is assigned to a same element appeared in the first embodiment, and the detailed description thereof is not presented.

In the first embodiment, the region B being free of groove 2a provided in the central portion of the polishing pad 2, and the slurry dropping position is located outside of the region B of the polishing pad 2 being free of the groove 2a. However, in the present embodiment, slurry dropping position is not particularly limited. Since the slurry 8 generally moves from the inner side of the polishing pad 2 toward the outer portion by the centrifugal force and cannot move toward the inner direction, the slurry feeder 7 extends to the interior of the region B being free of groove 2a as shown in FIG. 4, and even if the configuration, in which the slurry 8 is dropped in the region B, is employed, the slurry 8 cannot remain in the region B being free of groove 2a, and immediately moves into the region A having grooves 2a formed thereon by a centrifugal force. As a result, the present embodiment can provide the advantageous effect that is substantially similar to that obtained in the first embodiment. Further, as described above, since the wafer 3 rotates and oscillates, the portion contacting with the region B being free of groove 2a is not exactly defined, and some deviation of the slurry dropping position may be permitted as the target thereof is to generally provide a uniform polishing rate.

### Third Embodiment

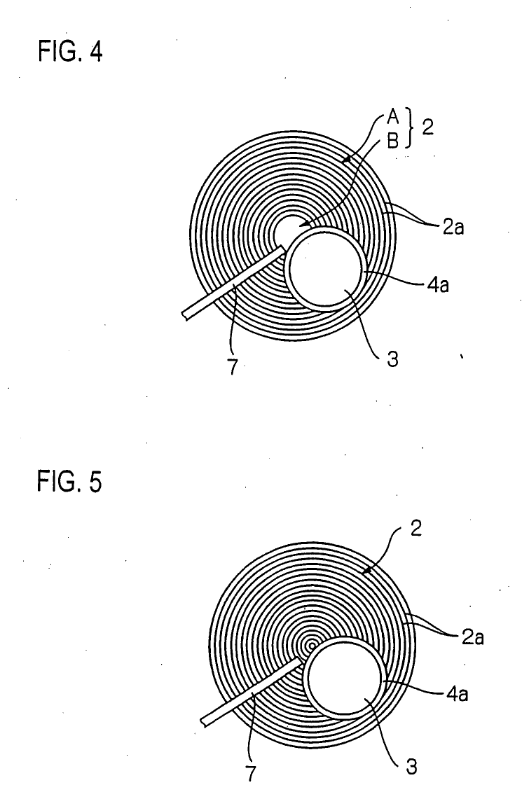

A third embodiment according to the present invention will be described as follows in reference to FIG. 5. Here, an identical numeral is assigned to a same element appeared in the first and the second embodiments, and the detailed description thereof is not presented.

In the first embodiment, the region B being free of groove 2a is provided in the central portion of the polishing pad 2. On the other hand, grooves 2a are formed over the entire surface of the polishing pad in the present embodiment. However, the slurry dropping position is disposed at a position outer from the central portion by a predetermined distance similarly as in the first embodiment, or in other words, at a position outer than the region that is desirable to have reduced polishing rate. Even if the grooves 2a exist in the central portion of the wafer 3, the slurry 8 moves from the inner side of the polishing pad 2 to the outer side thereof by a centrifugal force, and cannot move toward the inner side. Therefore, even if grooves 2a exist thereon in the location closer to the center than the slurry dropping position, substantially no slurry 8 moves into the grooves 2a. As a result, the present embodiment can provide the advantageous effect that is substantially similar to that obtained in the first and the second embodiments. Since the uniform polishing rate can be provided in the present embodiment by employing the polishing pad 2 having the conformation, which is different from that of the first embodiment, it can be speculated that the present invention can be applied to the polishing pad 2 of various conformations.

### Fourth Embodiment

A fourth embodiment according to the present invention will be described as follows in reference to FIG. 6. Here, an identical numeral is assigned to a same element appeared in the first to the third embodiments, and the detailed description thereof is not presented.

In the first embodiment, the region B being free of groove 2a is provided in the central portion of the polishing pad 2. On the other hand, in the present embodiment, the region B being free of groove 2a is provided in the circumference portion of the polishing pad 2a, and the region A having grooves 2a formed thereon is provided in the inner portion (central portion) thereof. Then, the retainer ring 4a and the wafer 3 are disposed so that a portion of the circumference portion of the wafer 3, that is, the portion that provides higher polishing rate around the retainer ring 4a, (for example, toroidal region having a width of about 10 mm from the circumference edge), faces against the region B being free of groove 2a of the circumference portion of the circular polishing pad 2, and then the polishing operation is conducted. The retainer ring 4a and the wafer 3 are reciprocating and oscillating to continue to relatively move the wafer 3 against the polishing pad 2, and it is preferable that the circumference portion of the wafer 3 (for example, toroidal region having a width of about 10 mm from the circumference edge) is in contact with the region B of free of groove, as described above, as taking an average during the polishing operation. Since the groove 2a that functions as a transfer path for the slurry 8 is not formed thereon, substantially no slurry 8 moves to the region B, and thus the polishing rate is lower. Therefore, the present embodiment can provide the advantageous effect that is similar to that obtained in the first to the third embodiments.

While the first to the fourth embodiments described above is presented in consideration of the tendency of providing higher polishing rate in the circumference portion of the wafer 3 (for example, toroidal region having a width of about 10 mm from the circumference edge of the wafer), the present invention is not limited thereto. More specifically, the present embodiment can also be applied even in the case of causing a phenomenon that the polishing rate in the other region of the wafer 3 is partially increased. The possible cause for partially increasing the polishing rate, of course, is not limited to the floating (bouncing) of the polishing pad 2 around the retainer ring 4a. Then, a suitable configuration may be arbitrarily selected according to the locations of partially increasing the polishing rate of the wafer 3, from a group consisting of: (i) the configuration of providing the region for providing lower polishing rate in the central portion of the polishing pad 2 as in the first to the third embodiments; and (ii) the configuration of providing the region for providing lower polishing rate in the circumference portion of the polishing pad 2 as in the fourth embodiment.

In addition, while the grooves 2a are concentric circular in the aforementioned first to fourth embodiments, the geometry of the grooves 2a is not limited to a particular geometry. The grooves 2a may be formed to have arbitrary geometry such as grid-shape, spiral-shape or the like Further, while the polishing pad 2 is provided with the region B being free of groove 2a in the aforementioned first, second and fourth embodiments, a few grooves 2a may be formed in this region to provide lower density thereof, as long as the slurry feed is limited so that the polishing rate thereof is lower than the other region A.

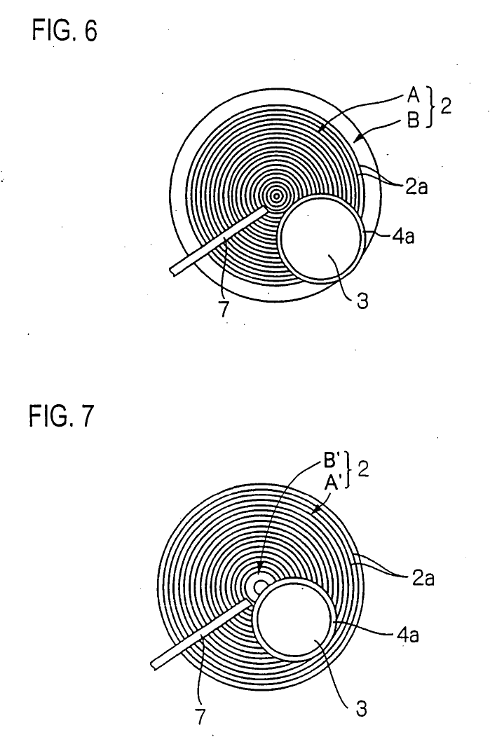

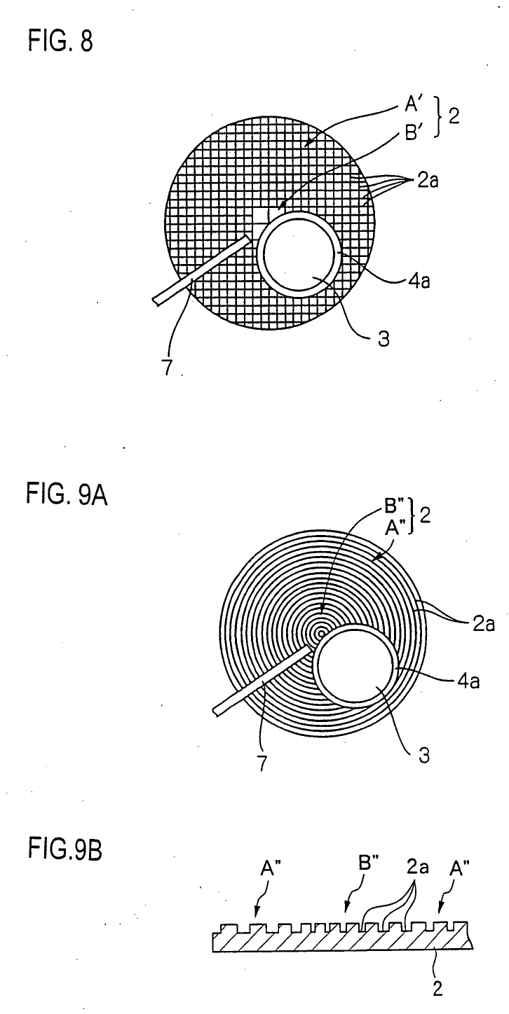

For example, as shown in FIG. 7 and FIG. 8, polishing can be conducted similarly as in the first embodiment except that the region A′ having grooves 2a formed thereon at higher groove density and the region B′ having grooves 2a formed thereon at lower groove density are utilized, to obtain similar advantageous effect. In this case, the outer shape of each of the regions A, A′, B and B′ is not necessarily circular. Although the description and the figures contained here illustrate for the convenience that the region A′ having grooves 2a formed thereon with higher density and the region B′ having grooves 2a formed thereon with lower density are clearly defined long the radial direction of the circular polishing pad 2, alternative configuration may also be provided, in which the density of the grooves 2a continuously changes along the radial direction of the polishing pad 2 and thus the entire pad surface can not simply be divided into the region A′ of higher density and the region B′ of lower density.

Alternatively, a configuration of having the region A″ having wider width of the concave portion of the grooves 2a formed thereon and the region B″ having narrower width of the concave portion of the grooves 2a formed thereon in the polishing pad 2 may be employed. For example, as shown in FIG. 9A and FIG. 9B, a configuration of providing the region B″ having narrower width of the concave portion of the grooves 2a in the central portion of polishing pad 2 and providing the region A″ having wider width of the concave portion of the grooves 2a in the circumference portion of polishing pad 2 may be employed. In this case, relatively larger quantity of the slurry 8 is supplied to the region A″ having wider width of the concave portion of the grooves 2a and smaller quantity of the slurry 8 is supplied to the region B″ having narrower width of the concave portion of the grooves 2a. Polishing process is conducted similarly as in the first embodiment except that the above-mentioned distribution of the slurry 8 based on the difference of the width of the concave portion is utilized to obtain similar effect thereto. Of course, an outer shape of each of the regions A″ and B″ are not necessary to be circular, and the grooves 2a are not limited to have a concentric circular geometry. Although the description and the figures contained here illustrate a configuration for the convenience, in which the region A″ having wider width of the concave portion of the grooves 2a and the region B″ having narrower width of the concave portion of the grooves 2a are clearly distinguished, alternative configuration may also be provided, in which width of the concave portion of the grooves 2a continuously changes and thus the entire pad surface can not simply be divided into region A″ of wider width and narrower region B″ of narrower width.

### Fifth Embodiment

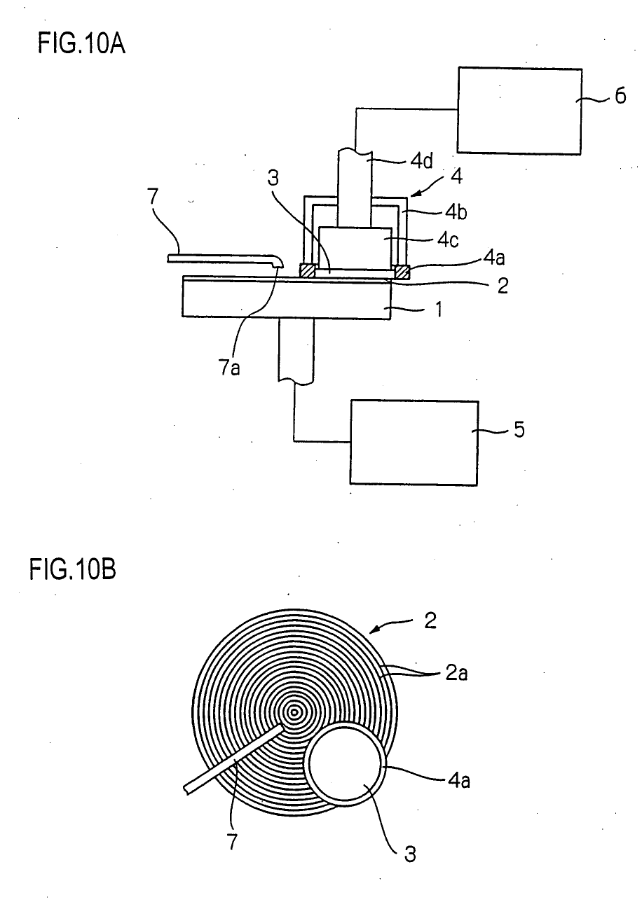

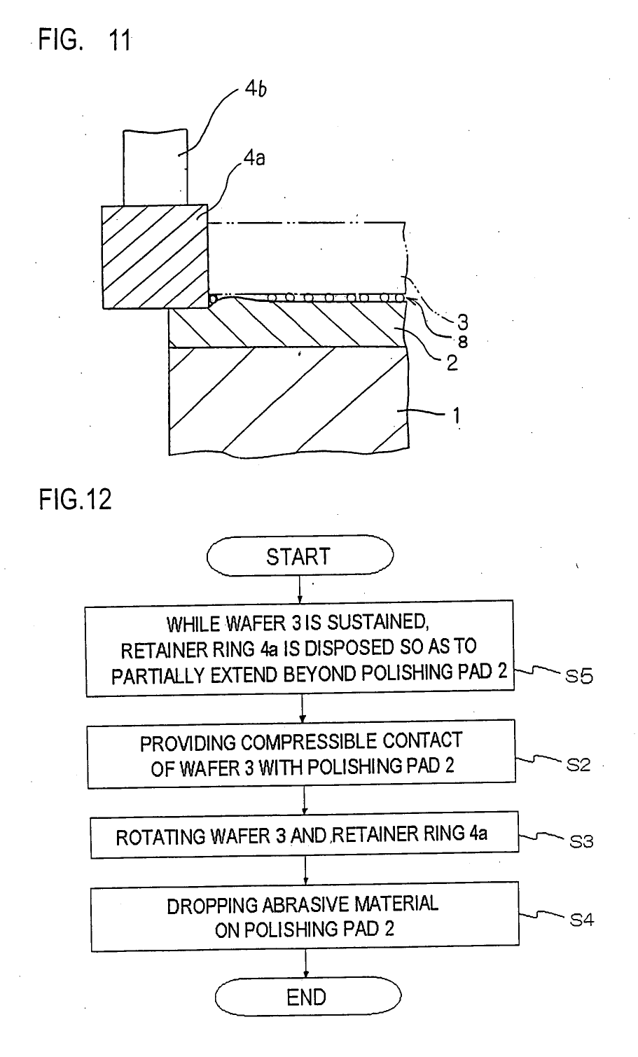

A fifth embodiment according to the present invention will be described as follows in reference to FIG. 10A, FIG. 10B, FIG. 11 and FIG. 12. Here, an identical numeral is assigned to a same element appeared in the first to the fourth embodiments, and the detailed description thereof is not presented.

As described above, the first to the fourth embodiments involve reducing the polishing rate of the circumference portion of the wafer 3 by polishing under the condition of having substantially no slurry 8, and thereby eventually providing the uniform polishing rate. On the contrary, the present embodiment partially prevents floating (bouncing) of the polishing pad caused by the retainer ring being in compressible contact with the polishing pad, as shown in FIG. 15B.

The present embodiment will be specifically described. The grooves 2a are formed over the entire surface of the polishing pad 2 similarly as in the second embodiment. As shown in FIG. 10A, FIG. 10B and FIG. 11, the circumference portion of the wafer 3 is located in the outer circumference edge portion of the polishing pad 2, and a condition in which the retainer ring 4a extends partially beyond the polishing pad 2 is obtained. As shown in FIG. 12, the circumference portion of the wafer 3 is sustained by the retainer ring 4a, and the retainer ring 4a is disposed so as to partially extend beyond an edge of the polishing pad 2 (step S5). Maintaining such condition, similarly as in each of the aforementioned embodiments, the wafer 3 is in compressible contact with the polishing pad 2 (step S2), and the polishing pad 2 is rotated and the wafer 3 is simultaneously rotated (step S3). Then, the slurry 8 is dropped on the polishing pad 2 (step S4) to conduct the polishing operation.

In such occasion, floating (bouncing) of the polishing pad 2 in the portion of the retainer ring 4a that extends beyond the edge of the polishing pad 2 is controlled to be smaller than the conventional, as shown in FIG. 11, thereby preventing an increase of the polishing rate. Of course, it is not always in the situation that the same place of the retainer ring 4a extend beyond the edge of the polishing pad 2 to reduce the polishing rate, since the retainer ring 4a continues to relatively move against the polishing pad 2 by rotating, reciprocating and oscillating the retainer ring 4a and the wafer 3. Nevertheless, after conducting the polishing operation for one piece of the wafer 3 for about 30 seconds to 3 minutes, the polishing rate in the circumference portion of the wafer 3 adjacent to the retainer ring 4a is, in general, reduced to a level substantially equivalent to that in the central portion. Eventually, similarly as in the embodiment shown in FIG. 3, the polishing rate in the circumference portion can be reduced to a level of about ±5% of the polishing rate in the central portion. For example, when the polishing rate in the central portion is 200 mm/min, the polishing rate in the circumference portion is about 190 to 210 mm/min. In this way, according to the present embodiment, uniform polishing rate over the wafer 3 is provided, and the flatness thereof is, in turn, improved, similarly as in the first to fourth embodiments.

While the present embodiment employs the polishing apparatus having the basic configuration that is same as the conventional apparatus including the polishing pad, only the location of the carrier 4 is changed to provide uniform polishing rate.

Method for Manufacturing Semiconductor Device

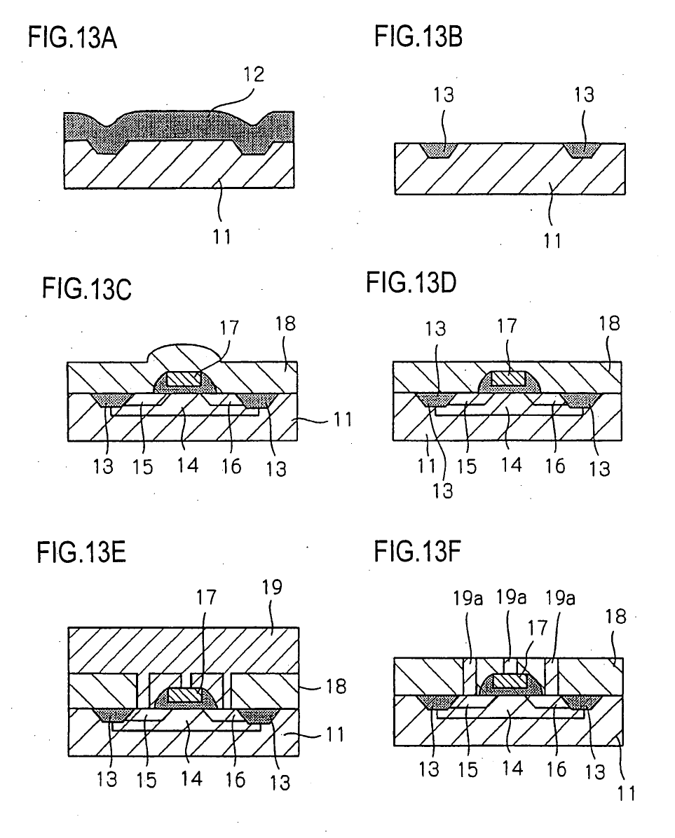

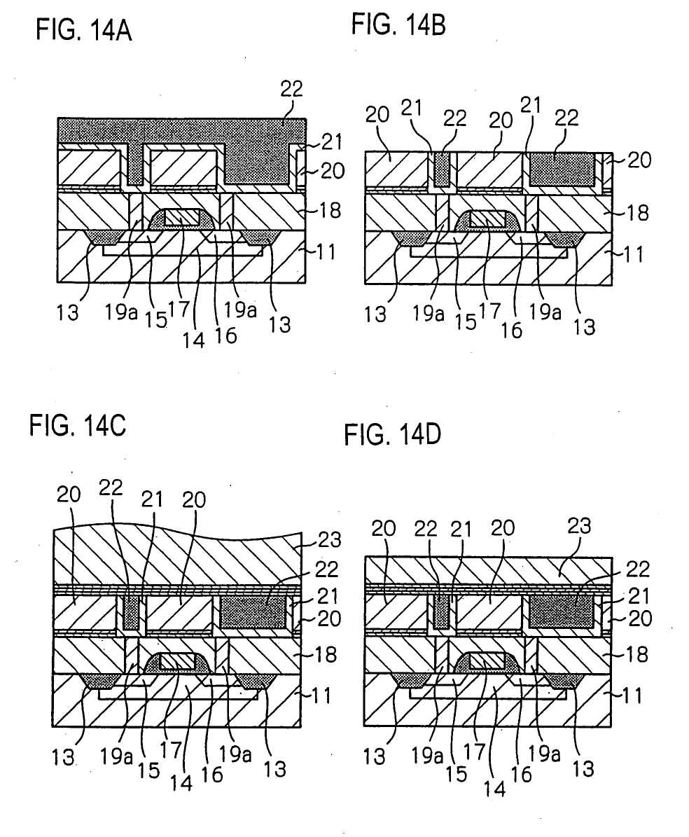

Next, a exemplary method for manufacturing a semiconductor device by utilizing the wafer polishing method using the polishing apparatus described in the above embodiments will be described in reference to FIGS. 13A to 13F and FIGS. 14A to 14D.

First of all, as shown in FIG. 13A, trenches are formed using a known lithography technology on a substrate (wafer body) 11 composed of silicon or the like (first processing step), and an oxide film 12 is formed on the surface of the substrate 11 having trenches formed thereon (first deposition step). Then, this surface is polished by using the polishing method illustrated in the aforementioned first to fifth embodiments (first polishing step) to form a shallow trench isolation (STI) 13, which is a trench-type device isolation portion, as shown in FIG. 13B. Subsequently, a well 14, a source region 15 and a drain region 16 are formed in a portion sandwiched by a pair of the STIs 13 of the substrate by utilizing a known ion implantation technology and a lithography technology, as shown in FIG. 13C, and further, a gate electrode 17 is formed on the surface to compose a transistor (creating step). Then, a boro-phospho silicate glass (BPSG) film 18 is deposited thereon (second deposition step).

After that, as shown in FIG. 13D, the aforementioned polishing method is conducted to planarize the surface of the BPSG film 18 (second polishing step). As shown in FIG. 13E, contact holes are formed in the BPSG film 18 by utilizing a known lithography technology (second processing step), and a tungsten film 19 is deposited to cover the BPSG film 18 and fill the contact holes (third deposition step). Then, the polishing method of the above-mentioned embodiments is conducted to remove the tungsten film 19 from the surface of the BPSG film 18, while leaving a portion of tungsten in the contact holes, as shown in FIG. 13F (third polishing step). As such, contacts 19a, that are coupled to the source region 15, the drain region 16, and the gate electrode 17, respectively, are exposed to the outside.

Thereafter, a known lithography technology is utilized to form an interlayer insulating film 20 as shown in FIG. 14A (fourth deposition step), and a trench is formed in the interlayer insulating film 20 (third processing step), and then barrier layers 21 and metal interconnection films 22 are deposited (fifth and sixth deposition steps). Then, as shown in FIG. 14B, the polishing method of the aforementioned embodiments is conducted to polish the metal interconnection films 22 and the barrier layers 21 (fourth polishing step). Further, as shown in FIG. 14C to FIG. 14D, an insulating film 23 is formed (seventh deposition step), and a polishing method of the above-mentioned embodiments is conducted to planarize thereof (fifth polishing step). As such, the semiconductor device is manufactured. In addition, thereafter, a known lithography technology and a known deposition technology and the polishing method of the above-mentioned embodiments may be utilized to repeat the formation of the interconnect layers and the vias.

The semiconductor device can be manufactured with higher accuracy when the all polishing processes are carried out by the polishing method of the above-mentioned embodiments. Nevertheless, an advantageous effect can also be obtained when at least one of the polishing process is conducted by utilizing the polishing the method of the above described embodiments. Here, each of the processes except the polishing processes may be conducted via conventionally known methods, and since the materials and configurations for each of the layers of the semiconductor devices are known, detailed description thereof is not presented. Further, each of the aforementioned processes may be appropriately omitted and/or may be modified.

It is apparent that the present invention is not limited to the above embodiment that may be modified and changed without departing from the scope and spirit of the invention.

What is claimed is:

1. A method for polishing a workpiece, comprising:
providing a compressible contact between a principal surface of a polishing pad and a polishing surface of a workpiece;
continuously moving a relative position of said polishing pad with said workpiece while the condition of being in compressible contact between said principal surface of said polishing pad and said polishing surface of said workpiece is maintained; and
supplying an abrasive material between said polishing pad and said workpiece,
wherein quantity of said abrasive material contacting said workpiece has a distribution profile over a region where the principal surface of said polishing pad is in contact with the polishing surface of said workpiece.

2. The method according to claim 1, wherein said abrasive material has a distribution profile over said polishing pad.

3. The method according to claim 2, wherein said polishing pad is rotated around a central axis, and said workpiece is oscillated on a region where said abrasive material has a distribution profile.

4. The method according to claim 3, wherein, on said polishing pad, quantity of said abrasive material is lower in a location that is closer to the center than a position where said abrasive material is dropped, and quantity of said abrasive material is higher in a location that is closer to the outer circumference than said position.

5. The method according to claim 3, wherein said polishing pad is provided with grooves formed thereon,
and wherein, on said polishing pad, quantity of said abrasive material is lower in a region where density of said grooves is lower, and quantity of said abrasive material is higher in a region where density of said.

6. The method according to claim 5, wherein density of said grooves is lower in a central region of said polishing pad, and density of said grooves is higher in a circumference region thereof.

7. The method according to claim 5, wherein said central region of said polishing pad is free of said groove.

8. The method according to claim 3, wherein said polishing pad is provided with grooves formed therein,
and wherein, on said polishing pad, quantity of said abrasive material is lower in a region where a width of a concave portion in said groove is narrower, and quantity of said abrasive material is higher in a region where a width of a concave portion in said groove is wider.

9. The method according to claim 8, wherein a width of a concave portion in said groove is narrower in a central region of said polishing pad, and a width of a concave portion in said groove is wider in a circumference region of said polishing pad.

10. The method according to claim 1, further comprising:
providing a compressible contact between a principal surface of said polishing pad and a polishing surface of said workpiece, so that at least a portion on the polishing surface of said workpiece, which tends to provide higher polishing rate, is located in a region on the principal surface of said polishing pad, which contains less quantity of said abrasive material.

11. The method according to claim 10, wherein a ring-type retainer surrounds a circumference portion of said workpiece to sustain said workpiece, and
wherein said portion on the polishing surface of said workpiece, which tends to provide higher polishing rate, is a portion of said circumference portion being adjacent to said ring-type retainer.

12. A method of polishing a workpiece, comprising:
providing a compressible contact between a principal surface of a polishing pad and a polishing surface of a workpiece;
continuously moving a relative position of said polishing pad against said workpiece while the condition of being in compressible contact between said principal surface of said polishing pad and said polishing surface of said workpiece is maintained; and
supplying an abrasive material between said polishing pad and said workpiece,
wherein a circumference portion of said workpiece is sustained with a ring-type retainer, and
wherein said polishing pad is in compressible contact with said workpiece, while said ring-type retainer is disposed so that at least a portion of said ring-type retainer extends beyond an edge of said polishing pad.

13. A method for manufacturing a semiconductor device, comprising:
creating a conducting region within a wafer by utilizing an ion implantation technology;
forming an insulating layer and/or a conducting layer by utilizing a deposition technology, both of said layers composing a portion of said wafer;
processing said wafer into a predetermined shape by utilizing a lithography technology; and
recognizing said wafer as a workpiece and conducting the method for polishing the workpiece according to claim 1.

14. A method for manufacturing a semiconductor device, comprising:
forming an insulating film on the semiconductor substrate; and
polishing a surface of said insulating film to planarize the surface of said insulating film,
wherein said polishing is conducted by utilizing said method for polishing the workpiece according to claim 1.

15. A method for manufacturing a semiconductor device, comprising:
forming an insulating film on the semiconductor substrate;
forming a groove on said insulating film;
forming a conducting film within said groove and on said insulating film; and
polishing at least a portion of said conducting film formed on said insulating film to planarizing a surface composed of the surface of said insulating film and the surface of said conducting film,
wherein said polishing is conducted by utilizing said method for polishing the workpiece according to claim 1.

16. A method of polishing a wafer, comprising:
using a polishing pad having a non-zero diameter center region and an annular region surrounding said center region, said annular region having a greater density of grooves therein than said center region;
rotating said polishing pad;
contacting the wafer with said polishing pad with a peripheral part of the wafer over said center region and to rotate the wafer; and
feeding an abrasive material while an abrasive material feeding unit controlling the amount of said abrasive material in said center region to be less than in said annular region.

17. The method of polishing a wafer according to claim 16,
said feeding unit does not discharge the abrasive material radially inward of an innermost annulus of said annular region so that the abrasive material avoids said center region.
